(19) United States
(12) Patent Application Publication
(10) Pub. No.: US 2005/0003094 A1
(43) Pub. Date: Jan. 6, 2005

(54) Thermally initiated polymerization process

(76) Inventors: Michael Charles Grady, Oaklyn, NJ (US); Congling Quan, Fort Lee, NJ (US); Masoud Soroush, Robbinsville, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/850,019

(22) Filed: May 19, 2004

Related U.S. Application Data
(60) Provisional application No. 60/484,393, filed on Jul. 2, 2003.

(51) Int. Cl. B05D 3/02; C08F 10/00

(52) U.S. Cl. 427/372.2; 526/319; 526/303.1; 526/341; 526/317.1; 526/346; 526/330; 526/284

(57) ABSTRACT

The present invention is directed to a thermally initiated polymerization process. The process provides for heating in a reactor a reaction mixture comprising one or more acrylate monomers to a polymerization temperature ranging from 120° C. to 500°0 C., and polymerizing the reaction mixture into a polymer. Applicants made an unexpected discovery that acrylate monomers can be used as thermal initiators, which makes the process more economical than conventional thermally initiated polymerization processes. The reaction mixture can also include non-acrylate monomers. Several novel steps are also disclosed to control the molecular weight and the polydispersity of the resulting polymer are also disclosed. The polymers made by the low cost process of the present invention have wide application, such as in automotive OEM and refinish coating compositions.

### FIELD OF THE INVENTION

The present invention generally pertains to thermally initiated free radical polymerization processes and more particularly pertains to thermally initiated free radical polymerization processes that utilize less expensive starting materials than conventional thermally initiated polymerization processes.

### BACKGROUND OF THE INVENTION

In a typical thermally initiated free radical polymerization process, a thermal initiator is added to monomer mixture, typically in an organic solvent or aqueous medium, in a reactor maintained at sufficiently high elevated reaction temperatures for the thermal initiator to undergo scission that results in a chemically reactive free radical. Such free radical then reacts with the monomers present to generate additional free radicals as well as polymer chains. Typical conventional thermal initiators include monofunctional peroxides, such as benzoyl peroxide, and t-butyl peroxybenzoate; azo initiators, such as azobisisobutyronitrile; and multifunctional peroxides, such as 1,1-bis(t-butylperoxy)-3,3,5-trimethylcyclo hexane and 2,2-bis(4,4-di-t-butylperoxycyclohexyl)propane. Such conventional thermal initiators are normally used in amounts of from 0.05 weight percent to 25 weight percent based on the total weight of the monomer mixture.

The thermal initiator utilized in the aforedescribed thermally initiated free radical polymerization process tends to be fairly expensive. Moreover, once the polymerization process has been completed the presence of the residual groups from thermal initiators in the polymer can affect the polymer properties, such as its resistance to actinic radiation, for example UV radiation.

Thus, need exists for a thermally initiated free radical polymerization process that not only produces polymers having improved polymer properties, but also does not use expensive thermal initiators such as those currently employed.

It is known that styrene monomer can act as a free radical thermal initiator to produce polystyrene polymers at elevated polymerization temperatures. However, a need still exists for a polymerization process in which the molecular weight of the resulting polymer can be controlled by using a low cost polymerization process.

### STATEMENT OF THE INVENTION

The present invention is directed to a process of polymerization comprising:
heating in a reactor a reaction mixture comprising one or more acrylate monomers to a polymerization temperature ranging from 120° C. to 500° C.; and
polymerizing said reaction mixture into a polymer.

The present invention is also directed to a process of producing a coating on a substrate comprising:
applying a layer of a coating composition comprising a polymer polymerized by heating in a reactor a reaction mixture comprising one or more acrylate monomers to a polymerization temperature ranging from 120° C. to 500° C.; and polymerizing said reaction mixture into said polymer;
curing said layer into said coating on said substrate.

### DETAILED DESCRIPTION OF THE PREFERRED EMBODIMENT

The polymerization process suitable for use in the present invention can be a batch process where all the components needed for the polymerization are added to the reactor in one shot, the so-called shot process, or a semi-batch or semi-continuous process where some of the reaction mixture is added initially to the reactor, heated to reaction temperature, and the balance of the reaction mixture fed over time to the reactor.

The forgoing polymerization process can be a continuous process where all the components needed for the polymerization are continuously fed to a reactor and the resulting polymer continuously removed from the reactor. The reactor can be either a continuous stirred tank reactor or a tubular reactor, wherein the reaction mixture is fed at one end of the tubular reactor maintained at the polymerization temperature and the resulting polymer is continuously removed from the other end of the tubular reactor. It is contemplated that plurality of tubular reactors positioned in parallel relationship to one another can be used to increase the throughput of the polymerization process. The residence time of the reaction mixture in the tubular reactor can be also controlled by varying the length/inner diameter (L/D). Thus, the higher the L/D ratio the longer will be the residence time and vice versa. Alternatively, or in addition to the foregoing, the rate at which the reaction mixture is transported through the tubular reactor can be increased or decreased to either reduce or increase the residence time. Some aspects of the foregoing tubular reactors have been described in the U.S. Pat. No. 5,710,227, which is incorporated herein by reference.

Any of the foregoing steps can include separate streams of a monomer mixture and the thermal initiator of the present invention is fed to the reactor continuously over a certain time period. Alternatively, a portion of the initiator can be added to the polymerization medium maintained at a polymerization temperature, followed by the addition of a portion of the reaction mixture. Thereafter, separate streams of the remainders of the reaction mixture and the initiator can be fed to the reactor continuously over a certain time period.

Applicants have unexpectedly discovered that acrylate monomers can be used as thermal initiators in the free radical polymerization process at elevated polymerization temperatures. One or more acrylate monomers at a concentration ranging from 5 weight percent to 100 weight percent, all weight percentages being based on total weight of the monomer mixture can be used as thermal initiators. The concentrations are dependent upon the desired polymer properties. The present thermally initiated polymerization process is carried out in the absence of conventional thermal initiators described earlier, since the acrylate monomers by themselves thermally initiate the process of polymerization and thereafter become part of the resulting polymer. The polymerization temperature can range from 120° C. to 500° C., preferably from 140° C. to 300° C., and more preferably from 140° C. to 220° C. The pressure in the reactor is adjusted to attain and maintain the aforedescribed polymerization temperatures. It should be noted that based on the boiling point of the polymerization medium, one can, if so desired, carry out the polymerization at elevated pressures. Typically the reactor gage pressure can range from 0.1 to 2.86 MPa (0 to 400 psig), preferably from 0.1 to 0.71 MPa (0 to 100 psig). It is understood that the higher the polymerization temperature, the higher will be the reactor pressure for a given composition of monomers and solvent.

Often, the monomer mixture is solvated in a polymerization medium, either an organic solvent or water to form the reaction mixture. If the monomer and resulting polymer are soluble in the medium, homogeneous polymerization takes place. If the monomer or resulting polymer are not soluble in the medium heterogeneous polymerization takes place. Typical polymerization media include one or more organic solvents, such as acetone, methyl amyl ketone, methyl ethyl ketone, Aromatic 100 (an aromatic solvent blend) from ExxonMobil Chemical, Houston, Tex., xylene, toluene, ethyl acetate, n-butyl acetate, t-butyl acetate, butanol, and glycol ether, such as diethylene glycol monobutyl ether. Thus, the higher the boiling point of the polymerization medium, the higher the polymerization temperature can be. Typical aqueous polymerization medium can include miscible co-solvents, such as ethanol, propanol, methyl ethyl ketone, n-methylpyrrolidone, and glycol and diglycol ethers. For example, when used to make polymers for powder coating compositions the concentration of the monomer mixture in the reaction mixture can range from 70 to 100 weight percent. When used to make polymers for enamel coating compositions, the concentration can range from 40 to 90 weight percent. When used to make polymers for lacquer coating compositions, the concentration can range from 10 to 70 weight percent. All the foregoing weight percentages are based on the total weight of the reaction mixture. It is also possible to form the polymer in organic polymerization medium to which aqueous medium is added and the organic solvent is then stripped to form an aqueous dispersion of the polymer.

Typically, the reactor containing the reaction mixture is maintained under an inert atmosphere, such as that provided by nitrogen or argon.

Preferably, the reaction mixture in the reactor is maintained under a state of reflux, which is attained by condensing and feeding back to the reactor any evaporated component of the polymerization medium in the reactor containing the reaction mixture.

If desired, the acrylate monomers can be fed at a constant rate to the reactor. If the monomer mixture includes non-acrylate monomers, separate streams of the acrylate monomers and non-acrylate monomers can be fed simultaneously at constant rate to the reactor. It would be obvious that the rates would be different, depending upon the type of polymer desired. Alternatively, the acrylate monomers and non-acrylate monomers could be premixed and then fed to the reactor. It is also within the scope of the present invention to feed the acrylate monomers first followed by the non-acrylate monomers. It is further contemplated that the polymerization medium can be fed to the reactor first, which is heated to the polymerization temperatures followed by the feeding of the acrylate and non-acrylate monomers in the fashion described above.

The present invention contemplates that the acrylate and non-acrylate monomers being fed to the reactor can be dissolved or suspended in the polymerization medium before they are fed to the reactor.

Typical reaction time ranges from about 30 seconds to 24 hours, typically 1 hour to 12 hours, generally from about 2 hours to 4 hours.

The acrylate monomer suitable for use as a thermal initiator can be provided with one or more groups selected from the group consisting of linear C₁ to C₂₀ alkyl, branched C₃ to C₂₀ alkyl, cyclic C₃ to C₂₀ alkyl, bicyclic or polycyclic C₅ to C₂₀ alkyl, aromatic with 2 to 3 rings, phenyl, C₁ to C₂₀ fluorocarbon and a combination thereof.

More particularly, the acrylate monomer suitable for use as a thermal initiator can be methyl acrylate, ethyl acrylate, propyl acrylate, butyl acrylate, pentyl acrylate, hexyl acrylate, octyl acrylate, nonyl acrylate, isodecyl acrylate, and lauryl acrylate; branched alkyl monomers, such as isobutyl acrylate, t-butyl acrylate and 2-ethylhexyl acrylate; and cyclic alkyl monomers, such as cyclohexyl acrylate, methylcyclohexyl acrylate, trimethylcyclohexyl acrylate, tertiarybutylcyclohexyl acrylate and isobornyl acrylate. Any combinations of the foregoing acrylate monomers can also be used. Additionally, the acrylate monomers suitable for use as thermal initiators can be provided with one or more pendant moieties. Some examples of suchacrylate monomers include hydroxyl alkyl acrylate, such as hydroxyethyl acrylate, and hydroxypropyl acrylate, hydroxybutyl acrylate; acrylic acid, acryloxypropionic acid, and glycidyl acrylate. Methyl acrylate, ethyl acrylate, hydroxypropyl acrylate, hydroxyethyl acrylate, hydroxybutyl acrylate, isobutylacrylate, 2-ethylhexyl acrylate and n-butyl acrylate are preferred.

Applicants have discovered that acrylic monomers can be used not only as thermal initiators to initiate polymerization of other monomers, but they can be also used by themselves to produce homopolymers (when a single type acrylate monomer is used) or used to produce copolymers (when a mixture of acrylate monomers is used as thermal initiators).

In addition to the foregoing, various non-acrylate monomer mixture combinations can also be thermally initiated by one or acrylate monomers. Some of the non-acrylate monomers that can be thermally initiated by the acrylate monomers can include alkyl esters of methacrylic acids, such as methyl methacrylate, ethyl methacrylate, butyl methacrylate and isobutyl methacrylate, isobornyl methacrylate, hydroxyalkyl esters of methacrylic acids, such as, hydroxyethyl methacrylate, hydroxypropyl methacrylate, hydroxyisopropyl methacrylate, and hydroxybutyl methacrylate; aminoalkyl methacrylates, such as N-methylaminoethyl methacrylate, N,N-dimethylaminoethyl methacrylate, and tertiarybutylaminoethyl methacrylate; methacrylamide, N-methylmethacrylamide, NN-dimethylmethacrylamide, methacrylic acid, methacrylonitrile, allyl alcohol, allylsulfonic acid, allylphosphonic acid, vinylphosphonic acid, dimethylaminoethyl acrylate, phosphoethyl methacrylate, N-vinylpyrrolidon, N-vinylformamide, N-vinylimidazole, vinyl acetate, styrene, α-methyl styrene, styrenesulfonic acid and its salts, vinylsulfonic acid and its salts, and; carboxylic acids, such as, methacrylic acid, crotonic acid, vinylacetic acid, maleic acid, maleic anhydride, itaconic acid, mesaconic acid, fumaric acid, citraconic acid, tetrahydrophthalic arthydrides, cydohexene dicarboxylic acids and salts thereof.

If desired one or more silane functionalities can be incorporated into the copolymers of the present invention preferably by post reacting hydroxyl functionalities on the copolymer with isocyanatopropyl trimethoxy silane. The reaction is conducted on an equivalent basis with equivalents of isocyanate, from the isocyanatopropyl trimethoxy silane, to hydroxyl groups, on the copolymer, ranging from 0.01 to 1.0.

Furthermore, the applicants have discovered that, for example, by manipulating the concentration of monomer and temperature of the polymerization, the architecture of the resulting polymer can be controlled.

Thus, the molecular weight of the polymer, such as GPC weight average molecular weight, can be reduced by one or more of the following steps:
increasing the concentration of said acrylate monomer in the monomer mixture from 5 weight percent to 100 weight percent, preferably from 20 weight percent to 90 weight percent, and more preferably from 40 weight percent to 80 weight percent;
increasing the polymerization temperature from 120° C. to 500° C., preferably from 140° C. to 300° C., and more preferably from 140° C. to 220° C.;
decreasing the conversion of said monomer mixture into polymer from about 100% to less than about 20%, preferably from about 80% to less than about 30%, and more preferably from about 70% to less than about 50%; and
reducing concentration of the monomer mixture in a reaction mixture from about 100% to about 2%, preferably from about 90% to about 30%, and more preferably from about 80% to about 40%, all percentages being based on the total weight of the reaction mixture.

It should be noted that in the foregoing process steps one does not increase the concentration of the acrylate monomer in the monomer mixture during the polymerization. The steps are attained by the initial selection of these steps. Thus, if one desires to produce a polymer having lower molecular weight, one would “increase”, i.e., use more of the acrylate monomer in the reaction mixture when producing the polymer than using less of the acrylate monomer in the monomer mixture at the start up. Thus, the forgoing process steps provide the polymer engineer with predictable process guidance on what process steps are to be used to get a polymer having the desired polymer architecture. The GPC weight average molecular weight of the resulting polymer attained by the process of the present invention can vary from 1000 to 100,000, preferably from 1,500 to 40,000, more preferably from 2,000 to 20,000. Even higher or lower molecular weight can be attained by proper selection of the monomers used in the reaction mixture.

The polydispersity of the resulting polymer attained by the process of the present invention can vary from 1.3 to 4.0, preferably from 1.5 to 2.5, more preferably from 1.6 to 2.0.

The polymers made by the process of the present invention typically include on an average 50 to 95 percent of the polymers having terminal unsaturated group (—C═CH₂). As a result, the polymers of the present invention can be advantageously used as macromonomers for producing block and graft copolymers. Thus, one can readily conventionally polymerize a second reaction mixture in the presence of the polymer of the present invention having terminal unsaturated group to produce block or graft copolymers. The second reaction mixture can contain any of the aforedescribed monomers. Unlike, the conventional processes, which typically require expensive organometallic chain transfer agents, such as cobalt (II or III) chelate, to produce the terminally unsaturated macromonomers, the present invention utilizes no such chain transfer agents. Such a process is described in the U.S. Pat. No. 5,587,431, which is incorporated herein by reference. Moreover, since the organometallic chain transfer agents are very difficult and expensive to remove from the resulting polymer solutions, their presence in the resulting compositions can adversely affect the properties of the coatings resulting therefrom. By contrast, since the macromonomers produced by the process of the present invention do not use the organometallic chain transfer agents, the coating properties of the resulting compositions are not adversely affected. Moreover, the cost of producing the block and graft copolymers from the terminally unsaturated macromonomers by the process of the present invention is also less than the conventional methods that use the expensive the organometallic chain transfer agents.

The present invention is also directed to the polymer produced by a process of the present invention. The present invention is also directed to coating compositions and adhesives containing the polymer produced by the process of the present invention.

The present invention is also directed to a process of producing a coating on a substrate comprising:
applying a layer of a coating composition comprising a polymer polymerized by heating in a reactor a reaction mixture comprising one or more acrylate monomers to a polymerization temperature ranging from 120° C. to 500° C.; and polymerizing said reaction mixture into the polymer;
curing the layer into said coating on the substrate, such as an automotive body.

It is contemplated that the polymer produced by the process of the present invention can be provided with a one or more crosslinkable functionalities either in the polymer backbone or pendant from the polymer backbone to form a crosslinkable component of a one pack or two-pack coating composition. The foregoing functionalities can include acetoacetoxy; hydroxyl; epoxide; silane; amine; and carboxyl. The polymer can be provided with such functionalities by including in the reaction mixture monomers that contribute such functionalities to the resulting polymer, such as for example, hydroxylethyl methacrylate. The crosslinking component can include one or more crosslinking agents, such as polyisocyanates, monomeric and polymeric melamines, polyacids, polyyepoxies, polyamines and polyketimines.

For two pack coating compositions, the two components, stored in separate containers are mixed just prior to use to form a pot mix, which is then applied as a layer on a substrate. The pot mix layer is then cured under ambient or elevated bake cure temperatures to form the coating on the substrate. During the cure, the crosslinkable functionalities on the polymer, such as hydroxyls, crosslink with the crosslinking functionalities from the crosslinking agent, such as isocyanates, to form a crosslinked network, such as polyurethane, that produces a durable, etch resistant coating.

When polyisocyanate is used as the crosslinking agent, the isocyanates can be blocked, with a suitable blocking agent, such as lower aliphatic alcohols, such as methanol; oximes, such as methylethyl ketone oxime, and lactams, such as epsiloncaprolactam. Blocked isocyanates can be used to form shelf stable one-pack coating composition, wherein the crosslinking component containing the blocked crosslinking agent is packed in the same container to form the one-pack coating composition. When a layer of the one-pack coating composition is applied over a substrate, the isocyanates from the blocked crosslinking agent are unblocked at elevated bake cure temperatures to form a coating of the crosslinked structures in the manner described above.

The process of the present invention can also used to produce a stabilized acrylic resin having (1) a core of acrylic polymer which is non-soluble in organic solvent and, grafted thereto, (2) a plurality of substantially linear stabilizer components, each of which is soluble in organic solvent and has one end of the stabilizer molecule grafted to the core. The process for producing the foregoing a stabilized acrylic resin is described in the U.S. Pat. No. 4,746,71, which is incorporated herein by reference. The process of the present invention can used to produce the core of the stabilized acrylic resin in which the acrylate monomer is utilized as the thermal initiator.

Since no conventional thermal initiators are used, the cost of manufacture of the polymers is less than conventional polymerization processes that utilize conventional thermal initiators. As a result, the polymers and copolymers of the present invention find wide application. The polymers and copolymers of the present invention can be use in automotive OEM (original equipment manufacturer) and refinish coating applications. The polymers of the present invention are suitable for use in the primers, pigmented base coating compositions and clear coating compositions used in the automotive applications. When the present coating composition is used as a basecoat, typical pigments that can be added to the composition include the following: metallic oxides, such as titanium dioxide, zinc oxide, iron oxides of various colors, carbon black; filler pigments, such as talc, china clay, barytes, carbonates, silicates; and a wide variety of organic colored pigments, such as quinacridones, copper phthalocyanines, perylenes, azo pigments, indanthrone blues, carbazoles, such as carbozole violet, isoindolinones, isoindolones, thioindigo reds, benzimidazolinones; metallic flake pigments, such as aluminum flakes.

The polymers and copolymers produced by the method of the present invention can be also used in marine applications, such as coating compositions for ship hulls, jetties; industrial coatings; powder coatings; ink jet inks; coating compositions for aircraft bodies; and architectural coatings.

### EXAMPLES

### Example 1

### n-Butyl acrylate homopolymer polymerized at 140° C.

To a 1.5-liter flask 540 grams of xylene were added and then heated to 140° C. while bubbling nitrogen through the solvent. Thereafter, 360 grams of n-butyl acrylate already purged with nitrogen were added to the flask within five minutes. The reaction mixture, which contained 40 weight percent of the monomer was held at 140° C. for 3 hours. The resulting polymer had a GPC weight average molecular weight of 19839 and GPC number average molecular weight of 8238, using polystyrene as standard. By gas chromatography, it was determined that 72 percent of the monomer was converted into the polymer.

### Example 2

### n-butyl acrylate homopolymer polymerized at 160° C.

To a 1.5-liter flask 540 grams of xylene were added and then heated to 160° C. while bubbling nitrogen through the solvent. Thereafter, 360 grams of n-butyl acrylate already purged with nitrogen were added to the flask within five minutes. The reaction mixture, which contained 40 weight percent of the monomer, was held at 160° C. for 2.5 hours. The resulting polymer had a GPC weight average molecular weight of 9657 and GPC number average molecular weight of 4314, using polystyrene as standard. By gas chromatography, it was determined that 83 percent of the monomer was converted into the polymer.

### Example 3

### n-butyl acrylate homopolymer polymerized at 180° C.

To a 1.5-liter flask 540 grams of xylene were added and then heated to 180° C. while bubbling nitrogen through the solvent. Thereafter, 360 grams of n-butyl acrylate already purged with nitrogen were added to the flask within five minutes. The reaction mixture, which contained 40 weight percent of the monomer, was held at 180° C. for 1.7 hours. The resulting polymer had a GPC weight average molecular weight of 6206 and GPC number average molecular weight of 2563, using polystyrene as standard. By gas chromatography, it was determined that 86 percent of the monomer was converted into the polymer.

### Example 4

### n-butyl acrylate polymerized in refluxing methyl amyl ketone

To a 1.5-liter flask 700 grams of methyl amyl ketone were added and then heated to reflux, 150° C. to 155° C., while bubbling nitrogen through the solvent. Thereafter, 300 grams of n-butyl acrylate already purged with nitrogen were added to the flask within five minutes. The reaction mixture, which contained 30 weight percent of the monomer, was held at reflux for 4.0 hours. The resulting polymer had a GPC weight average molecular weight of 9965 and GPC number average molecular weight of 3934, using polystyrene as standard. By gas chromatography, it was determined that 99 percent of the monomer was converted into the polymer.

### Example 5

### hydroxypropyl acrylate polymerized in refluxing methyl amyl ketone

To a 1.5-liter flask 700 grams of methyl amyl ketone were added and then heated to reflux, 150° C. to 155° C., while bubbling nitrogen through the solvent. Thereafter, 300 grams of hydroxy propyl acrylate already purged with nitrogen were added to the flask within five minutes. The reaction mixture, which contained 30 weight percent of the monomer, was held at reflux for 4.0 hours. The resulting polymer had a GPC weight average molecular weight of 2039 and GPC number average molecular weight of 1648, using polystyrene as standard. By gas chromatography, it was determined that greater than 99 percent of the monomer was converted into the polymer.

### Example 6

### methyl acrylate polymerized in refluxing methyl amyl ketone

To a 1.5-liter flask 700 grams of methyl amyl ketone were added and then heated to reflux, 150° C. to 155° C., while bubbling nitrogen through the solvent. Thereafter, 300 grams of methyl acrylate already purged with nitrogen were added to the flask within five minutes. The reaction mixture, which contained 30 weight percent of the monomer, was held at reflux for 4.0 hours. The resulting polymer had a GPC weight average molecular weight of 53887 and GPC number average molecular weight of 11277, using polystyrene as standard. By gas chromatography, it was determined that 85 percent of the monomer was converted into the polymer.

### Example 7

### n-butyl acrylate/n-butyl methacrylate co-polymerized in refluxing methyl amyl ketone

To a 1.5-liter flask 700 grams of methyl amyl ketone were added and then heated to reflux, 150° C. to 155° C., while bubbling nitrogen through the solvent. Thereafter, 180 grams of n-butyl acrylate and 120 grams of n-butyl methacrylate already purged with nitrogen were added to the flask within five minutes. The reaction mixture, which contained 30 weight percent of the monomer in an initial ratio of 60/40 n-butyl acrylate to n-butyl methacrylate by weight, was held at reflux for 4.0 hours. The resulting polymer had a GPC weight average molecular weight of 18540 and GPC number average molecular weight of 6850, using polystyrene as standard. By gas chromatography, it was determined that 100 percent of the n-butyl acrylate and 97 percent of the n-butyl methacrylate were converted into the polymer.

### Example 8

### hydroxy ethyl acrylate/n-butyl methacrylate co-polymerized in refluxing methyl amyl ketone

To a 1.5-liter flask 700 grams of methyl amyl ketone were added and then heated to reflux, 150° C. to 155° C., while bubbling nitrogen through the solvent. Thereafter, 180 grams of hydroxy ethyl acrylate and 120 grams of n-butyl methacrylate already purged with nitrogen were added to the flask within five minutes. The reaction mixture, which contained 30 weight percent of the monomer in an initial ratio of 60/40 hydroxy ethyl acrylate to n-butyl methacrylate by weight, was held at reflux for 4.0 hours. The resulting polymer had a GPC weight average molecular weight of 23730 and GPC number average molecular weight of 6762, using polystyrene as standard. By gas chromatography, it was determined that 99 percent of the n-butyl acrylate and 99 percent of the n-butyl methacrylate were converted into the polymer.

1. A process of polymerization comprising:
heating in a reactor a reaction mixture comprising one or more acrylate monomers to a polymerization temperature ranging from 120° C. to 500° C.; and
polymerizing said reaction mixture into a polymer.

2. The process of claim 1 wherein said reaction mixture comprises from 5 weight percent to 100 weight percent of said acrylate monomers, said weight percentages based on total weight of said reaction mixture.

3. The process of claim 1 wherein said acrylate monomers are selected from the group consisting of linear C₁ to C₂₀ alkyl, branched C₃ to C₂₀ alkyl, cyclic C₃ to C₂₀ alkyl, bicyclic or polycyclic C₅ to C₂₀ alkyl, aromatic with 2 to 3 rings, phenyl, C₁ to C₂₀ fluorocarbon and a combination thereof.

4. The process of claim 1 wherein said acrylate monomers are selected from the group consisting of C₁ to C₂₀ alkyl acrylate, hydroxy alkyl acrylate, epoxy acrylate, and a combination thereof.

5. The process of claim 2 wherein said reaction mixture further comprises non-acrylate monomers.

6. The process of claim 5 wherein said non-acrylate monomers comprise alkyl esters of methacrylic acids, hydroxyalkyl esters of methacrylic acids, aminoalkyl methacrylates, methacrylamide, dimethylaminopropylmethacrylamide, methacrylonitrile, allyl alcohol, allylsulfonic acid, allylphosphonic acid, vinylphosphonic acid, dimethylaminoethyl methacrylate, phosphoethyl methacrylate, N-vinylpyrrolidone, N-vinylformamide, N-vinylimidazole, vinyl acetate, styrene, α-methyl styrene, styrenesulfonic acid and salts thereof, vinylsulfonic acid and salts thereof; carboxylic acids, tetrahydrophthalic arthydrides, cydohexene dicarboxylic acids and salts thereof; or a combination thereof.

7. The process of claim 1 or 2 wherein said reaction mixture comprises a polymerization medium.

8. The process of claim 7 wherein said polymerization medium comprises one or more organic solvents selected from the group consisting of acetone, methyl amyl ketone, methyl ethyl ketone, xylene, toluene, ethyl acetate, n-butyl acetate, t-butyl acetate, butanol, glycol ether and a combination thereof.

9. The process of claim 7 wherein a GPC weight average molecular weight of the polymer is reduced by one or more of steps comprising:
increasing said concentration of said acrylate monomer in said monomer mixture from 5 weight percent to 100 weight percent;
increasing the polymerization temperature from 120° C. to 500° C.;
decreasing the conversion of said monomer mixture into said polymer from about 100% to less than about 20%; and
reducing concentration of said monomer mixture in a polymerization medium from 98% to 2% based on the total weight of the reaction mixture.

10. The process of claim 7 wherein said reactor containing said reaction mixture is maintained under an inert atmosphere.

11. The process of claim 10 wherein said inert atmosphere comprises nitrogen.

12. The process of claim 7 wherein said polymerization medium in said reactor is maintained under a state of reflux.

13. The process of claim 1 wherein said acrylate monomers are fed at a constant rate to said reactor.

14. The process of claim 7 wherein said acrylate monomers are fed at a constant rate to said reactor.

15. The process of claim 5 wherein said reactor comprises a polymerization medium.

16. The process of claim 5 or 15 wherein said acrylate monomers and said non-acrylate monomers are fed at a constant rate to said reactor.

17. A polymer produced by the process of claim 1 or 5.

18. The process of claim 1 wherein said polymer is terminally unsaturated.

19. The process of claim 18 further comprising polymerizing a second reaction mixture in the presence of said polymer to produce a block copolymer or a graft copolymer.

20. A coating composition comprising a polymer polymerized by heating in a reactor a reaction mixture comprising one or more acrylate monomers to a polymerization temperature ranging from 120° C. to 500° C.; and
polymerizing said reaction mixture into said polymer.

21. The coating composition of claim 20 wherein said reaction mixture further comprises non-acrylate monomers.

22. An adhesive comprising a polymer polymerized by heating in a reactor a reaction mixture comprising one or more acrylate monomers to a polymerization temperature ranging from 120° C. to 500° C.; and
polymerizing said reaction mixture into said polymer.

23. The adhesive of claim 22 wherein said reaction mixture further comprises non-acrylate monomers.

24. A process of producing a coating on a substrate comprising:
applying a layer of a coating composition comprising a polymer polymerized by heating in a reactor a reaction mixture comprising one or more acrylate monomers to a polymerization temperature ranging from 120° C. to 500° C.; and polymerizing said reaction mixture into said polymer;
curing said layer into said coating on said substrate.

25. The process of claim 24 wherein said substrate is an automotive body.
